(19) United States
(12) Patent Application Publication
(10) Pub. No.: US 2025/0199567 A1
(43) Pub. Date: Jun. 19, 2025

(54) SECURE TIMEKEEPING METHODS, APPARATUS, SYSTEMS, AND CONTROL PRIMITIVES

(71) Applicants: Bin Xing, Hillsboro, OR (US); Shanwei CEN, Portland, OR (US); Mona Vij, Portland, OR (US); Kevin STANTON, Hillsboro, OR (US); Bo Zhang, Raleigh, NC (US)

(72) Inventors: Bin Xing, Hillsboro, OR (US); Shanwei CEN, Portland, OR (US); Mona Vij, Portland, OR (US); Kevin STANTON, Hillsboro, OR (US); Bo Zhang, Raleigh, NC (US)

(21) Appl. No.: 18/544,328

(22) Filed: Dec. 18, 2023

(51) Int. Cl. G06F 1/14; G06F 21/62

(52) U.S. Cl. CPC G06F 1/14; G06F 21/6218

(57) ABSTRACT

An apparatus of an aspect includes timer circuitry to provide a timer value based at least in part on a timer offset, and an execution unit to perform operations corresponding to a timekeeping control primitive. The timekeeping control primitive is to indicate a destination storage location. The operations include to determine the timer offset based on at least one timer offset control, and to store either the timer offset, or a deterministically obfuscated version of the timer offset, in the destination storage location. Other apparatus, methods, systems, and timekeeping control primitives are disclosed.

### BACKGROUND

### Technical Field

Embodiments described herein generally relate to processors and other integrated circuits. In particular, embodiments described herein generally relate to timekeeping in processors and other integrated circuits.

### Background Information

Many processors have a timer to provide a timer value. Some processors have an instruction in their instruction set that may be used to read the timer value of the timer. One known instruction to read a timer value is the RDTSC (Read Time-Stamp Counter) instruction. This RDTSC instruction when executed may cause the processor to read the current value of the processor's time-stamp counter (TSC) (a 64-bit MSR) into the EDX:EAX registers. The EDX register may be loaded with the high-order 32 bits of the MSR and the EAX register may be loaded with the low-order 32 bits.

### BRIEF DESCRIPTION OF THE DRAWINGS

Various examples in accordance with the present disclosure will be described with reference to the drawings, in which:

FIG. 1 is a block diagram of an example computer system in which embodiments of the invention may be implemented.

FIG. 2 is a block diagram of an embodiment of an apparatus that is operative to perform an embodiment of a timekeeping control primitive.

FIG. 3 is a block diagram of an embodiment of a processor that is operative to perform an embodiment of a timekeeping instruction 328.

FIG. 4 is a block diagram of an embodiment of an apparatus that is operative to perform an embodiment of a timekeeping command.

FIG. 5 is a block diagram of an example embodiment of an execution unit for a timekeeping control primitive.

FIG. 6 is a block flow diagram of an embodiment of a method of processing an embodiment of a timekeeping control primitive.

FIG. 7 illustrates an example computing system.

FIG. 8 illustrates a block diagram of an example processor and/or System on a Chip (SoC) that may have one or more cores and an integrated memory controller.

FIG. 9(A) is a block diagram illustrating both an example in-order pipeline and an example register renaming, out-of-order issue/execution pipeline according to examples.

FIG. 9(B) is a block diagram illustrating both an example in-order architecture core and an example register renaming, out-of-order issue/execution architecture core to be included in a processor according to examples.

FIG. 10 illustrates examples of execution unit(s) circuitry.

FIG. 11 is a block diagram of a register architecture according to some examples.

FIG. 12 illustrates examples of an instruction format.

FIG. 13 illustrates examples of an addressing information field.

FIG. 14 illustrates examples of a first prefix.

FIGS. 15(A)-(D) illustrate examples of how the R, X, and B fields of the first prefix in FIG. 14 are used.

FIGS. 16(A)-(B) illustrate examples of a second prefix.

FIG. 17 illustrates examples of a third prefix.

FIG. 18 is a block diagram illustrating the use of a software instruction converter to convert binary instructions in a source instruction set architecture to binary instructions in a target instruction set architecture according to examples.

### DETAILED DESCRIPTION OF EMBODIMENTS

Disclosed herein are embodiments of timekeeping control primitives, embodiments of apparatus to perform the timekeeping control primitives, embodiments of methods of performing the timekeeping control primitives, embodiments of systems to perform the timekeeping control primitives, and embodiments of programs or machine-readable mediums storing instructions to perform operations as described for the timekeeping control primitives. In the following description, numerous specific details are set forth (e.g., specific timer controls, processor configurations, microarchitectural details, operations, sequences of operations, etc.). However, embodiments may be practiced without these specific details. In other instances, well-known circuits, structures and techniques have not been shown in detail to avoid obscuring the understanding of the description.

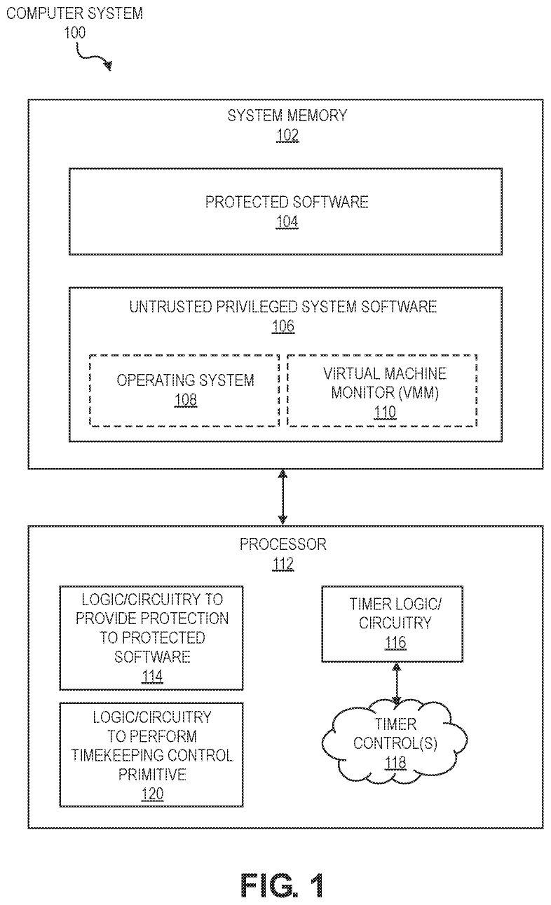

FIG. 1 is a block diagram of an example computer system 100 in which embodiments of the invention may be implemented. In various embodiments, the computer system may represent a server, a desktop computer, a laptop computer, a notebook computer, a tablet computer, a smartphone, a set-top box, a network device (e.g., a router, switch, etc.), or various other types of computer systems known in the art.

The computer system includes a system memory 102. The system memory may include one or more types of memory and/or one or more types of memory devices. Examples of suitable types of memory include, but are not limited to, random access memory (RAM) such as dynamic random access memory (DRAM), non-volatile memory such as erasable programmable read-only memory (EPROM), electrically erasable programmable read-only memory (EEPROM), other types of read-only memory (ROM), and flash memory, other types of memory known in the art, and combinations thereof.

Protected software 104 and untrusted privileged system software 106 may be stored in the system memory. The protected software may broadly represent software (e.g., user-level applications) that is isolated or otherwise protected (e.g., confidentiality and/or integrity protected) from other software (e.g., the untrusted privileged system software). In various embodiments, the protected software may represent a hardware-isolated virtual machine (VM), a secure VM, a protected VM execution space, a protected container, a protected area in the address space of a program in which only code within that protected area can access code and data within that protected area, or the like.

The untrusted privileged system software may broadly represent privileged system software that is untrusted by the protected software (e.g., privileged system software that is outside of a Trusted Computing Base (TCB) of the protected software). The untrusted privileged system software may be untrusted in part because there is a chance that it could become corrupted or compromised and could steal secrets (e.g., cryptographic keys, confidential data, passwords, etc.) if it was not considered untrusted and corresponding precautions were not taken. Typically, the untrusted privileged system software may include at least one operating system 108 (e.g., a standard operating system (OS), real-time OS, a highly stripped-down operating environment with limited conventional OS functionality). In some cases, the untrusted privileged system software may also include at least one virtual-machine monitor (VMM) 110. The VMM is sometimes also referred to as a hypervisor. The VMM may present or expose to other software (e.g., referred to as “guest” software) the abstraction of one or more virtual machines (VMs). The VMM may emulate or otherwise provide a bare machine interface to the VMs. The VMM may help to manage the VMs (e.g., manage resource allocation for the VMs). In some embodiments, a VM may include a guest OS and the protected software. In some cases, the untrusted privileged system software may optionally include multiple VMMs (e.g., nested VMMs). The VMM is used with some but not all types of protected software.

To further illustrate certain concepts, a few specific examples of the protected software 104 and the untrusted privileged system software 106 will be described. One specific example of the protected software is an Intel® Software Guard Extensions (Intel® SGX) secure enclave. The secure enclave may represent a protected container. The secure enclave may represent code and data (e.g., in a protected memory area) that is protected from access by code outside of the secure enclave (e.g., the untrusted privileged system software). The secure enclave can be used either with or without the VMM. The code and data of the enclave may be encrypted and integrity protected by a cryptographic unit of the processor when resident outside of the processor and only the processor may know the encryption key. This may help to protect the secure enclave even in the presence the untrusted privileged system software (e.g., a corrupt OS or VMM).

Another specific example of the protected software is an Intel® Trust Domain Extensions (Intel® TDX) trust domain (TD). The TD may represent a hardware-isolated VM. The TD may be hardware-isolated from the VMM and other non-TD software. The TD may use a protection management module known as a Secure Arbitration Mode (SEAM) module. At a high level, the SEAM module may serve as an intermediary between the protected software and the VMM to help manage the security or protection of the protected software from the VMM.

Another specific example of the protected software is an ARM realm. The realm may represent a protected execution environment or protected virtual machine that executes in realm security state. The realm may use a protection management module known as a Realm Management Monitor (RMM). At a high level, the RMM module may serve as an intermediary between the protected software and the VMM to help manage the security or protection of the protected software from the VMM.

Another specific example of the protected software is an AMD Secure Encrypted Virtualization (SEV) VM. Contents of the SEV VM may be encrypted with cryptographic key of the SEV VM that is kept secret from the VMM when the contents are stored to the system memory.

Yet another specific example of the protected software is an AMD SEV Secure Nested Paging (SEV-SNP) VM. Like with SEV, the contents of the SEV-SNP VM may be encrypted with cryptographic key of the SEV VM that is kept secret from the VMM when the contents are stored to the system memory. In addition, access to pages of the SEV-SNP VM may be restricted based on ownership, page type, and other attributes maintained in a Reverse Map Table (RMP).

Referring again to FIG. 1, the computer system also includes at least one processor 112. In some embodiments, the processor may be a general-purpose processor (e.g., a general-purpose microprocessor or central processing unit (CPU) of the type used in desktops, laptops, servers, and other computer systems). Alternatively, the processor may be a special-purpose processor. Examples of suitable special-purpose processors include, but are not limited to, co-processors, security processors, graphics processors (e.g., general-purpose GPUs), network processors, machine-learning processors, artificial intelligence processors, and controllers (e.g., microcontrollers). The processor and the system memory are coupled, or otherwise in communication with one another (e.g., through one or more buses, hubs, memory controllers, chipset components, or the like).

The processor may include circuitry and/or other logic 114 to allow the protected software to execute in a way that is protected from the untrusted privileged system software. The logic/circuitry may support any one or more of the previously described types of protections, such as, for example, encryption and decryption, integrity protection, access control checks, restricting access to code and/or data within the processor, and the like. For example, the logic/circuitry may include cryptographic logic/circuitry to encrypt code and data of the protected container before it is transmitted to the system memory and to decrypt the encrypted code and data when it is loaded into the processor, logic/circuitry to mark or tag the decrypted code and data when it is resident in internal structures of the processor, access control logic/circuitry (e.g., a memory management unit (MMU)) to restrict access to the code and data of the protected software, and so on. Any of the various protections used for SGX secure enclaves, TDs, SEV VMs, SEV-SNP VMs, or other protected software known in the arts, are suitable. The logic/circuitry may provide a trusted execution environment (TEE), a protected execution environment, hardware-isolated execution environment from all untrusted software, or the like, to allow the protected software to execute protected from the untrusted privileged system software.

Referring again to FIG. 1, the processor has timer circuitry and/or other logic 116. The timer logic/circuitry may also be referred to herein simply as a timer. The timer may be operative to maintain and/or provide a timer value. In some embodiments, the timer may be operative to count and/or increment and/or decrement on clock cycles. By way of example, the timer may include a register that may be monotonically incremented or decremented each clock cycle. Commonly, the register may have at least 32-bits (e.g., be a 64-bit register). The timer may be set to a starting value (e.g., reset to zero) under certain circumstances (e.g., when the processor is reset).

Different types of timers are suitable. One specific example of a suitable timer is the Time Stamp Counter (TSC) in certain x86 architecture processors. Another specific example of a suitable timer is the TICK register in certain SPARC V9 processors. Another specific example of a suitable timer is the 64-bit TBR register in certain PowerPC processors. Yet another specific example of a suitable timer is the generic counter which counts at a constant frequency in certain ARMv7 and ARMv8-A architecture processors. Timers similar to such timers should generally also be suitable.

In some embodiments, the timer may increment (or decrement) with every internal processor clock cycle and the internal processor clock cycle may be affected by the current variable core-clock to bus-clock ratio as well as dynamic frequency scaling (e.g., SpeedStep® technology). In other embodiments, the timer may increment (or decrement) at a constant rate. The rate may be set by the maximum core-clock to bus-clock ratio of the processor or may be set by the maximum resolved frequency at which the processor is booted. The maximum resolved frequency may differ from the processor base frequency. In still other embodiments, the timer may be an invariant timer (e.g., an invariant TSC) that may increment (or decrement) at an invariant or constant rate that does not vary according to the core's frequency and that is invariant or constant across power states (e.g., all ACPI P-states, C-states, and T-states).

The timer logic/circuitry 116 may be operative to maintain and/or provide the timer value based on one or more timer controls 118. In some embodiments, the timer control(s) may optionally include at least one timer offset control to control (e.g., adjust) a timer offset used by the timer. In some embodiments, the timer control(s) may optionally include at least one timer frequency control to control (e.g., adjust) a frequency (e.g., of the clock cycles) used by the timer. In some embodiments, both at least one timer offset control and one timer frequency control may optionally be used. The timer controls are shown in a cloud to indicate that they may or may not be stored on the processor. In some cases, a timer control may be stored in a storage location of the processor (e.g., model specific registers (MSRs), control registers, configuration registers, or the like). In other cases, a timer control may be stored external to the processor (e.g., in a virtual machine control structure (VMCS), other virtualization control structure, or other data structure in the system memory).

Now, for a variety of reasons, the protected software 104 may need to keep track of time in a secure and trustworthy way that cannot be spoofed, compromised, or otherwise altered by the untrusted privileged system software 106. One such reason is that timekeeping is used in a wide variety of security-related processes, such as, for example, timing out sessions, limiting the rates of authentication attempts, expiration of certificates, limiting access rights for Digital Right Management (DRM), using Proof of Elapsed Time (PoET) as a consensus model for blockchain applications that uses random durations to determine (e.g., randomly and fairly) which validator to publish the next block, and so on.

Some processors provide support for an instruction to read the current value of a TSC or other timer (e.g., the timer logic/circuitry 116). For example, certain x86 processors support a RDTSC (Read Time-Stamp Counter) instruction. This RDTSC instruction when executed may cause the processor to read the current value of the TSC into the EDX:EAX registers. However, one challenge is that the RDTSC instruction is not able to support timekeeping in a secure and trusted way that cannot be spoofed, compromised, or altered by the untrusted privileged system software, since the value of the TSC is subject to modification (e.g., through scaling and/or offsetting) by the untrusted privileged system software 106. For example, for certain x86 architecture processors, the value of the TSC may be modified by the untrusted privileged system software modifying any one or more of: (1) a VMM level frequency multiplier for the TSC recorded in the TSC multiplier of the VM execution controls in the VMCS; (2) an operating system level offset to the TSC recorded in an IA32_TSC_ADJUST MSR; and (3) a VMM level offset to the TSC recorded in the TSC offset of the VM execution controls in the VMCS.

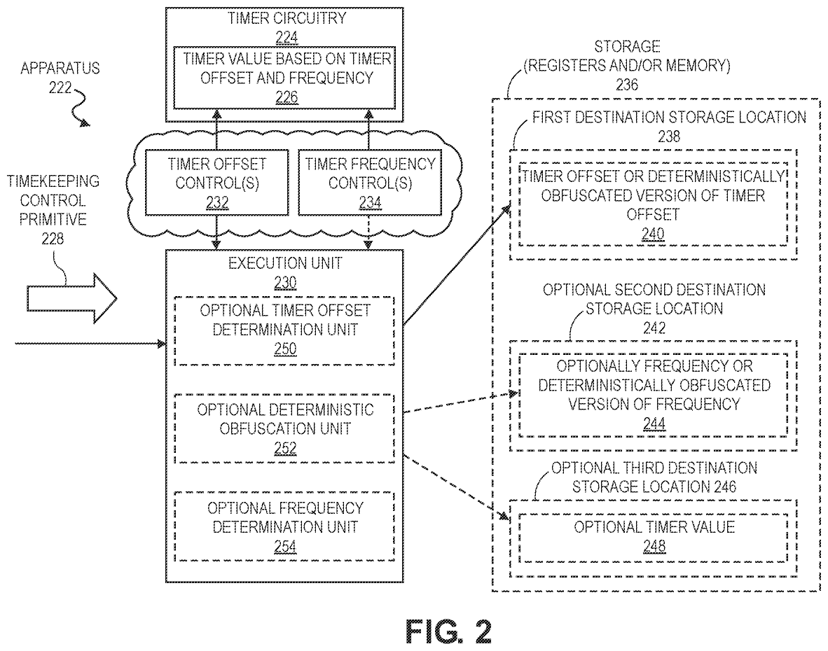

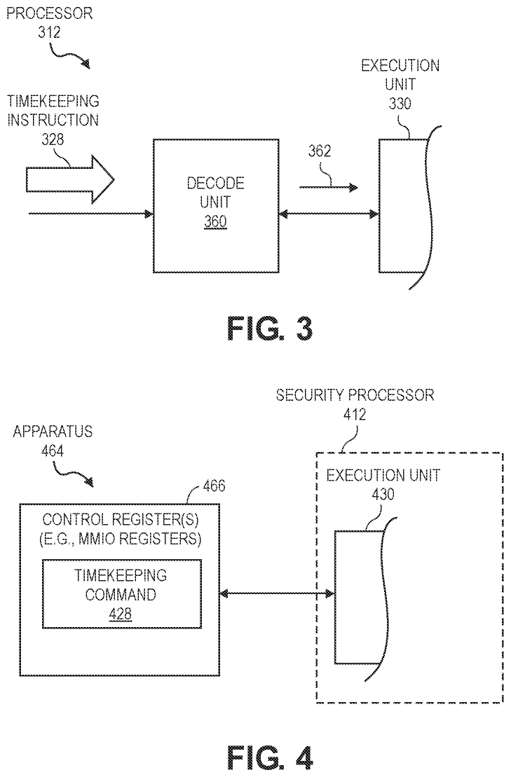

Referring again to FIG. 1, the processor includes circuitry and/or other logic 120 to perform a timekeeping control primitive. In some embodiments, the logic/circuitry 120 may include the execution unit 230 of FIG. 2. In some embodiments, the timekeeping control primitive may be the timekeeping instruction 328 of FIG. 3 and the logic/circuitry 120 may include the decode unit 360 and execution unit 330 of FIG. 3. In some embodiments, the timekeeping control primitive may be the timekeeping command 428 of FIG. 4 and the logic/circuitry 120 may include the execution unit 430 of FIG. 4.

FIG. 2 is a block diagram of an embodiment of an apparatus 222 that is operative to perform an embodiment of a timekeeping control primitive 228. In various embodiments, the apparatus may be a processor, an integrated circuit, a system-on-chip (SoC), or a computer system.

The apparatus may include timer circuitry 224 to maintain and/or provide a timer value 226. The timer circuitry may also be referred to herein simply as a timer. The timer value may be based at least in part on a timer offset and a frequency of the timer circuitry. In some embodiments, the timer may be operative to count and/or increment and/or decrement on clock cycles. By way of example, the timer circuitry may include a register that may be monotonically incremented or decremented each clock cycle. Commonly, the register may have at least 32-bits (e.g., be a 64-bit register). The timer circuitry may also be set to a starting value (e.g., reset to zero) under certain circumstances (e.g., when the processor is reset). Specific examples of suitable timer circuitry include, but are not limited to, an TSC (e.g., an invariant TSC), a TICK register, a 64-bit TBR register, a generic counter which counts at a constant frequency. Other timers similar to such timers are also suitable.

In some embodiments, the timer 224 is not an external time source that is external to the processor on which the protected software runs. In some embodiments, the timer is not a timer of a management engine (ME) or a timer of a Network Time Protocol (NTP) and/or Network Time Security (NTS) server. Such external timers are generally farther removed from the protected software than the timer. This tends to increase latency of receiving timekeeping information. Also, such external timers are often coupled via intervening components that can potentially introduce variable latencies. Also, such external timers are commonly not in the trusted computing base (TCB) of the protected software. While it is potentially possible to expand the TCB to include them, such expansion of the TCB generally tends to weaken security.

The timer circuitry 224 may provide the timer value consistent with and/or based on one or more timer offset controls 232 and one or more timer frequency controls 234. As one specific example embodiment, for certain x86 architecture processors, the timer controls may include: (1) a ratio (e.g., as reported by CPUID leaf 15H) between the frequency of the TSC and the frequency of invariant timekeeping hardware (e.g., the Always Running Timer (ART) that runs at the core crystal clock frequency); (2) a VMM level frequency multiplier for the TSC recorded in the TSC multiplier of the VM execution controls in the VMCS; (3) an operating system level offset to the TSC recorded in an IA32_TSC_ADJUST MSR; and (4) a VMM level offset to the TSC recorded in the TSC offset of the VM execution controls in the VMCS. It is to be appreciated that this is just one specific example and that other architectures and other processors may have fewer, more, and/or different types of timer controls. In some embodiments, different instances of the timer controls may optionally be stored for different instances of protected software (e.g., a first instance of the controls for a first protected software, a second instance of the controls for a second protected software, and so on). The timer control(s) 232, 234 are shown in a cloud to indicate that they may not necessarily be stored locally to the execution unit (e.g., on an integrated circuit) but may optionally be stored elsewhere (e.g., in a VMCS or other data structure in system memory).

To further illustrate how a timer offset control may be used as a VM execution control, consider the following example where the timer offset control value is used to represent or account for a difference between the actual value of the timer and the value of the timer expected by the protected software (e.g., a secure VM). The secure VM may start and may run until the actual value of the timer is 1000 ticks. Then, the secure VM may take a VM exit. Thereafter, either another VM or the VMM may run and the timer may increment for another 500 ticks. At this point, the actual value of the timer is 1500 ticks. At this point, the secure VM is entered. The secure VM may expect the timer to be at 1000 ticks, since it is unaware that either the other VM or the VMM ran for the 500 ticks, but the actual value of the timer is 1500 ticks. To help virtualize the timer for the secure VM, the VMM may apply an offset of −500 ticks to account for the difference between the value of the timer expected by the secure VM (e.g., 1000 ticks) and the actual value of the timer (e.g., 1500 ticks). Timer offset controls may also optionally be used to account for differences in timer values encountered when migrating the protected software from one computer system to another.

The apparatus may be coupled to receive the timekeeping control primitive 228. The timekeeping control primitive may explicitly specify (e.g., through one or more fields, values, etc.) or otherwise indicate (e.g., implicitly indicate) at least a first destination storage location 238 where at least a first result 240 is to be stored. The first destination storage location may optionally be in storage 236 which may include registers (e.g., general-purpose registers or other architectural registers of a processor) and/or memory (e.g., main memory or system memory).

Various different types of timekeeping control primitives are suitable. One example of a suitable timekeeping control primitive is a machine language instruction and/or an instruction of an instruction set of a processor. The instruction may have an operation code or opcode that at least partially specifies an operation to be performed. In some cases, one or more additional fields in the encoding of the instruction and/or one or more registers or other storage locations (e.g., memory locations) explicitly specified or otherwise indicated by the instruction may optionally be used to provide additional information to specify the operation to be performed. The instruction may explicitly specify (e.g., have one or more fields to specify) or otherwise indicate (e.g., implicitly indicate) one or more registers or other storage locations (e.g., memory locations) to provide input values and to receive output values (e.g., the first destination storage location). Further details of such a timekeeping instruction will be discussed further below in conjunction with FIG. 3.

Another example of a suitable timekeeping control primitive is an Application Binary Interface (ABI) command, Application Programming Interface (API) command, or other command (e.g., a command code, command identifier, etc.) that may be stored in one or more control registers (e.g., one or more memory-mapped input and/or output (MMIO) registers). The command may at least partially specify an operation to be performed. In some cases, one or more additional data structures and/or storage locations explicitly specified or otherwise indicated (e.g., implicitly indicated) by the command may optionally be used to provide additional information to specify the operation to be performed, to provide input values, and to receive output values (e.g., the first destination storage location). Further details of such a timekeeping command will be discussed further below in conjunction with FIG. 4.

Yet another example of a suitable timekeeping control primitive is a request or message transmitted to or otherwise provided via an interface. The request or message may at least partially specify an operation to be performed. In some cases, one or more additional data structures and/or storage locations explicitly specified or otherwise indicated (e.g., implicitly indicated) by the request or message may optionally be used to provide additional information to specify the operation to be performed, to provide input values, and to receive output values (e.g., the first destination storage location).

Referring again to FIG. 2, the apparatus includes an execution unit 230. The execution unit may be coupled with the storage 236 (e.g., registers and/or memory) to receive any optional input operands (e.g., none are shown in the illustrated embodiment, but other embodiments may optionally include one or more input operands) and to store one or more result operands. The execution unit may be operative to perform operations corresponding to the timekeeping control primitive. The operations may include to determine the timer offset based on at least one timer offset control 232. For example, in the case of certain x86 processors, the at least one timer offset control may include a first timer offset control (e.g., a timer offset control stored in IA32_TSC_ADJUST MSR) and a second timer offset control (e.g., a TSC offset VM execution control stored in a VMCS). As shown, the execution unit may optionally include a timer offset determination unit 250 to determine the timer offset. The operations may also include to store either the timer offset, or a deterministically obfuscated version of the timer offset 240, in the first destination storage location 238 indicated by the timekeeping control primitive.

One possible reason to use the deterministically obfuscated version of the timer offset is to help prevent the protected software from being able to detect the existence of a VMM (e.g., sometimes referred to as exposing a virtualization hole). For example, in certain x86 architecture processors, a timer offset value not matching that recorded in the IA32_TSC_ADJUST MSR may indicate the existence of a VMM since the difference may be attributed to a nonzero TSC offset VM execution control in the VMCS (e.g., which can be loaded with different nonzero values). For certain types of protected software (e.g., SGX secure enclaves) which are not natively aware of the existence of the VMM, it is often desirable for the instruction set architecture to avoid exposing such virtualization holes. Obfuscating the timer offset may help to avoid exposing such a virtualization hole. However, other types of protected software may be already natively aware of the existence of the VMM, so there may be no need to avoid exposing such a virtualization hole. For example, TDs, SEV VMs, SEV-SNP VMs, realms, and other types of protected software, are natively designed based on the existence of a VMM and are already natively aware of the existence of the VMM.

In some embodiments, where the deterministically obfuscated version of the timer offset is used, the operations may further include generating the deterministically obfuscated version of the timer offset with a deterministically obfuscating function or algorithm (e.g., performing operations of the function or algorithm on the timer offset). The deterministically obfuscating function or algorithm may have a first property or characteristic that it may always (or at least a vast majority of the time) provide the same output value for the same input value. The deterministically obfuscating function or algorithm may have a second property or characteristic that it may obfuscate the input value such that it is at least difficult if not impractical or even infeasible to determine the input value given the output value. In some embodiments, the deterministically obfuscating function or algorithm may also optionally have at least a weak collision resistance property or characteristic (e.g., it may be at least difficult if not impractical or even infeasible to determine two input values that generate the same output value).

Various different deterministically obfuscating algorithms are suitable and will be apparent to those skilled in the art and having the benefit of the present disclosure. Specific examples of suitable deterministically obfuscating algorithms include, but are not limited to, encryption algorithms (e.g., the Advanced Encryption Standard (AES), SM4, and less secure ones if desired (e.g., Data Encryption Standard (DES), Rivest Cipher 4 (RC4))), cryptographic hash algorithms (e.g., Secure Hash Algorithm 2 (SHA-2), Secure Hash Algorithm 3 (SHA-3), SM3, and even less secure ones if desired (e.g., MD4 message digest algorithm, MD5 message digest algorithm, Secure Hash Algorithm 1 (SHA-1))), and Hash-Based Message Authentication Codes (HMAC). Other types of pseudorandom functions (e.g., a function that can be used to generate an output from a random seed and a data variable such that the output computationally similar to truly random output) and collision resistant functions, are also suitable. As shown, the execution unit may optionally include a deterministic obfuscation unit 252 to obfuscate values (e.g., the timer offset) using any of these algorithms.

In some embodiments, the deterministically obfuscated version of the timer offset may optionally be obfuscated based on a platform unique value and/or a value that does not persist across boots of the associated computer system (e.g., the value may be ephemeral and/or may be regenerated to be a different value upon each boot). In some embodiments, the platform unique value and/or a value that does not persist across boots may further optionally be kept secret even from privileged system software. This is optional but may further help to provide protection. For example, this may help to protect against attacks based on migration from one platform to another and/or based on repeated migration (e.g., from platform A to platform B and then back to platform A with an intervening reboot of platform A). This may be done in different ways, such as, for example, by using different AES or other cryptographic keys for the obfuscations for the different platforms that are generated as per-boot unique values, incorporating different protected software identifiers unique to the different platforms into the obfuscations for the different instances, incorporating other protected software instance specific or platform specific information into the obfuscations for the different instances, etc. In some embodiments, the deterministically obfuscating function or algorithm may optionally be processor package specific. This may also be done in different ways, such as, for example, by using different cryptographic keys for the obfuscations for the different processor packages, incorporating different processor package identifiers or other processor package specific information into the obfuscations for the different instances, or the like. This may also be further unnecessary if the core crystal clock (e.g., ART) is synchronized across the processor packages.

In some embodiments, the deterministically obfuscated version of the timer offset may include more than 64 bits (e.g., may include at least 128 bits). Using a value of more than 64 bits may help reduce the risk of certain attacks (e.g., “birthday attacks”). In such cases, it may be convenient to use a memory location as the first destination storage location, since most general-purpose registers have 64 bits or less. Alternatively, a register larger than 64-bits may optionally be used (e.g., a 128-bit vector register) or multiple smaller registers may optionally be used (e.g., two 64-bit general-purpose registers). In some cases, to further help reduce the risk of such attacks, the protected software may not reveal the deterministically obfuscated offset to any untrusted software and/or may optionally abort whenever a change to the deterministically obfuscated offset is detected.

Referring again to FIG. 2, in some embodiments, the timekeeping control primitive may explicitly specify (e.g., through one or more fields or values) or otherwise indicate (e.g., implicitly indicate) an optional second destination storage location 242. In such embodiments, the operations may also optionally include determining a frequency of the timer circuitry 224 based on at least one timer frequency control 234. As shown, the execution unit may optionally include a frequency determination unit 254 to determine the frequency. The operations may also optionally include storing the frequency of the timer circuitry or a deterministically obfuscated version of the frequency of the timer circuitry 244 in the second destination storage location. Another possible approach is to determine and store the frequency or the obfuscated frequency by performing a different type of timekeeping control primitive.

The frequency may optionally be obfuscated if it desirable to help prevent the protected software from being able to detect the existence of a VMM (e.g., sometimes referred to as exposing a virtualization hole). However, certain types of protected software (e.g., TDs, realms, SEV VMs, SEV-SNP VMs, and the like) are natively already aware of the existence of the VMM, so there may be no need to avoid exposing such a virtualization hole. Furthermore, many modern day VMMs aim to maintain the same frequency throughout a guest's lifespan. Thus, a guest will not notice the existence of the underlying VMM if the same frequency is maintained. Accordingly, when there is no need to avoid exposing such a virtualization hole and/or when the VMM maintains the same frequency throughout a guest's lifespan, the frequency may optionally be provided directly in plaintext instead of being obfuscated. This may also offer a potential advantage of not only allowing detecting changes in the frequency (which can be done via deterministically obfuscated frequencies) but also being able to calculate secure and valid time durations (e.g., by multiplying the frequency by ticks elapsed which may be determined from two different timer values).

It is also possible in the case of the obfuscated frequency to combine or coalesce the obfuscated frequency and the obfuscated offset into a single obfuscated value. Since the values are obfuscated there may be no need to store multiple values. A change in one value combining both the obfuscated frequency and the obfuscated offset may reveal a change in either the frequency or the offset without needing to separately check for changes in two obfuscated values. This may also avoid needing storage locations to store two obfuscated values. Additional parameters may also optionally be combined or coalesced into the obfuscated value (e.g., AES or other key, another type of session identifier, etc.). For example, both a frequency and an offset may be encrypted with an AES key to generate one obfuscated value that can be used to detect changes in either the frequency or the offset.

In some embodiments, the timekeeping control primitive may explicitly specify (e.g., through one or more fields or values) or otherwise indicate (e.g., implicitly indicate) an optional third destination storage location 246. In such embodiments, the operations may also optionally include reading or loading the timer value 226 from the timer circuitry and storing the timer value 248 in the third destination storage location. Another possible approach is to determine and store the frequency or the obfuscated frequency by performing a different type of timekeeping control primitive (e.g., the RDTSC instruction). In some embodiments, differences between two timer values may be used to provide a number of clock cycles or ticks which may be optionally be used to calculate a time duration.

One possible advantage of reporting the frequency or obfuscated frequency 244 and/or the timer value in the same instruction is that they may be reported atomically along with the offset or obfuscated offset 240 (e.g., the timekeeping control primitive may either provide one of them or none of them). Providing none of them may be a result of taking an exception, returning an error code without returning the values, etc. Reporting them atomically may help to improve security by helping to avoid supervisory system software from manipulating timekeeping related parameters between the executions of the different control primitives (e.g., between execution of the timekeeping control primitive 228 and a RDTSC instruction). However, other approaches may also be used to help reduce such risks, such as, for example, executing the multiple control primitives transactionally, performing checks that the supervisory system software hasn't modified the timekeeping related parameters, etc.

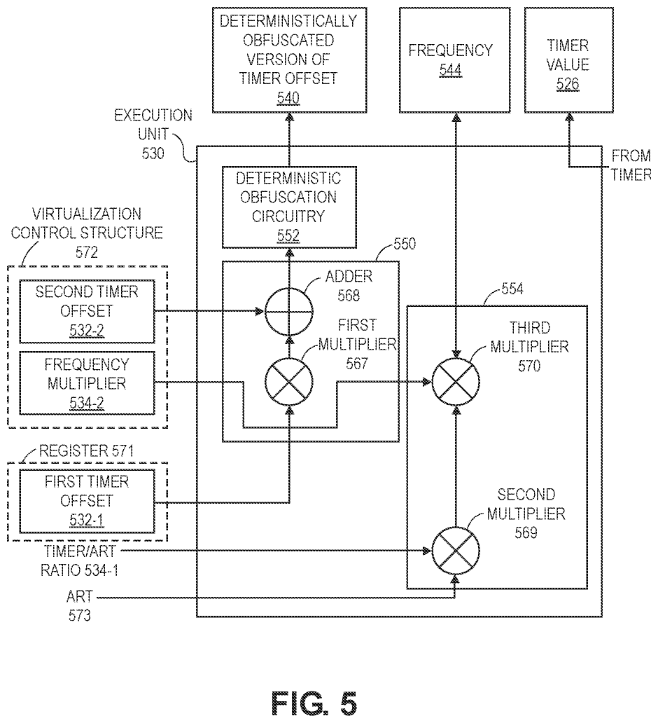

In some embodiments, the timer circuitry and/or the execution unit may be part of a processor. The previously described types of general-purpose and special-purpose processors are suitable. In some embodiments, the timer circuitry and/or the execution unit may include (e.g., be disposed on) at least one integrated circuit or semiconductor die. The execution unit 230 may be implemented in hardware (e.g., transistors, integrated circuitry, circuits), firmware (e.g., instructions stored in non-volatile memory), software (e.g., instructions stored in memory or a machine-readable storage medium), or combinations thereof. In some embodiments, the execution unit may include at least some hardware (e.g., transistors, capacitors, circuitry, non-volatile memory storing or to store circuit-level instructions/control signals). The execution unit may include specific or particular logic operative to perform the timekeeping control primitive (e.g., an adder (e.g., adder circuitry to add an offset, a multiplier (e.g., multiplier circuitry) to multiply a frequency ratio and/or frequency multiplier). In some embodiments, the execution unit may include the circuitry or logic shown and described for FIG. 5, although the scope of the invention is not so limited.

Advantageously, the timer offset or deterministically obfuscated timer offset may allow protected software to detect changes in the timer offset or deterministically obfuscated timer offset. Without limitation, detecting these changes may potentially allow the protected software to take precautions to prevent corrupted untrusted privileged system software from changing them maliciously (e.g., mounting a timing attack). In some cases, when the frequency is also provided (e.g., either by the secure timekeeping control primitive or a different control primitive), and the timer value is also provided (e.g., either by the secure timekeeping control primitive or a different control primitive such as the RDTSC instruction), the protected software may be able to calculate time durations securely and validly even in view of untrusted privileged system software being able to modify one or more timer frequency and/or offset controls. For example, the protected software may compare the frequencies returned from two instances of a timekeeping control primitive to make sure the frequencies have not changed and may compare the offsets or obfuscated offsets from two instances of the secure timekeeping control primitive to make sure they have not changed. Then, the protected software may calculate the time duration as the product of the frequency and the difference between the two timer values. It is to be appreciated that in some embodiments the timekeeping control primitives disclosed herein may also be regarded as general-purpose timekeeping control primitives that may also optionally be used by regular software not just protected software (e.g., the regular software may keep time or calculate time durations using the timekeeping information they provide).

FIG. 3 is a block diagram of an embodiment of a processor 312 that is operative to perform an embodiment of a timekeeping instruction 328. The previously described types of general-purpose and special-purpose processors are suitable. The processor may have any of various complex instruction set computing (CISC) architectures, reduced instruction set computing (RISC) architectures, very long instruction word (VLIW) architectures, or hybrid architectures. In some embodiments, the processor may include (e.g., be disposed on) at least one integrated circuit or semiconductor die. In some embodiments, the processor may include at least some hardware (e.g., transistors, capacitors, circuitry, non-volatile memory storing circuit-level instructions/control signals).

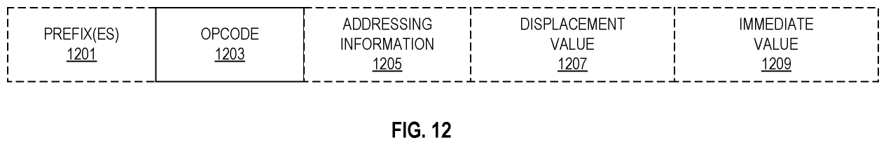

The processor includes a decode unit 360 (e.g., including decode circuitry). The decoder unit may be coupled to receive the timekeeping instruction. The timekeeping instruction may represent a macroinstruction, a machine code instruction, or an instruction of an instruction set of the processor. The timekeeping instruction may have an operation code or opcode that at least partially specifies an operation to be performed. In some embodiments, the timekeeping instruction may explicitly specify (e.g., through one or more fields or a set of bits in its encoding), or otherwise indicate (e.g., implicitly indicate), one or more source storage locations (e.g., in general-purpose or other registers and/or memory) and may explicitly specify (e.g., through one or more fields or a set of bits in its encoding), or otherwise indicate (e.g., implicitly indicate), one or more destination storage locations (e.g., in general-purpose or other registers and/or memory). In some cases, one or more source storage locations (e.g., a general-purpose register) may optionally be used (e.g., as a leaf) to provide additional information to specify the operation to be performed. The instruction may have various formats or encodings, such as, for example, those described further below (e.g., for FIGS. 12-17).

The decode unit may be operative to decode the timekeeping instruction into one or more lower-level control signals, operations, or decoded instructions 362 (e.g., one or more micro-instructions, micro-operations, micro-code entry points, or the like). The decode unit may be implemented using various instruction decode mechanisms including, but not limited to, microcode read only memories (ROMs), look-up tables, hardware implementations, programmable logic arrays (PLAs), other mechanisms suitable to implement instruction decode units, and combinations thereof. In some embodiments, the decode unit may include at least some hardware (e.g., transistors, integrated circuitry, on-die read-only memory or other non-volatile memory storing microcode or other hardware-level instructions, or any combination thereof). In some embodiments, the decode unit may be included on a die, integrated circuit, or semiconductor substrate.

An execution unit 330 (e.g., including execution circuitry) is coupled with the decode unit 360 (e.g., to receive the one or more lower-level control signals, operations, or decoded instructions). The execution unit may also be coupled to access the source and destination storage locations. In some embodiments, the execution unit may be on a die or integrated circuit along with the decode unit. The execution unit may be operative to perform operations corresponding to the timekeeping instruction 328. For example, one or more lower-level control signals, operations, or decoded instructions may control the execution unit to perform operations corresponding to the timekeeping instruction. The operations may be the same as or similar to those already described for FIG. 2. To avoid obscuring the description, those operations will not be repeated.

The processor may also have registers (not shown) that may optionally be used as the source and destination storage locations. These registers may represent architecturally-visible or architectural registers that are visible to software and/or a programmer and/or are the registers indicated by instructions of the instruction set of the processor to identify operands. These architectural registers are contrasted to other non-architectural registers in a microarchitecture (e.g., temporary registers, reorder buffers, retirement registers, etc.). These registers may be implemented in different ways in different microarchitectures and are not limited to any particular design. Examples of suitable types of registers include, but are not limited to, dedicated physical registers, dynamically allocated physical registers using register renaming, and combinations thereof. Specific examples of suitable registers include, but are not limited to, the general-purpose registers described further below.

FIG. 4 is a block diagram of an embodiment of an apparatus 464 that is operative to perform an embodiment of a timekeeping command 428. In various embodiments, the apparatus may be a processor, an integrated circuit, a system-on-chip (SoC), or a computer system.

The apparatus includes one or more control registers 466 coupled to receive and store the timekeeping command 428. In some embodiments, the control registers may be actual dedicated physical registers on a die or integrated circuit. In other embodiments, the control registers may be MMIO registers in memory, mailbox registers, or the like. The command may be an ABI command, an API command, or another type of command. The command may include a command code, command identifier, or the like. The command code or command identifier may at least partially specify an operation to be performed. In some cases, one or more registers and/or data structures and/or storage locations explicitly specified or otherwise indicated (e.g., implicitly indicated) by the command may optionally be used to provide additional information to specify the operation to be performed, to provide input values, and to receive output values.

An execution unit 430 (e.g., including execution circuitry) is coupled with the control register(s) 466. The execution unit may also be coupled to access the source and destination storage locations and/or data structures. As shown, in some embodiments, the execution unit may optionally be part of a security processor (e.g., a security coprocessor), although that is not required. The execution unit may include hardware, software, firmware, or a combination thereof. The execution unit may be operative to perform operations corresponding to the timekeeping command 428. The operations may be the same as or similar to those already described for FIG. 2. To avoid obscuring the description, those operations will not be repeated.

FIG. 5 is a block diagram of an example embodiment of an execution unit 530 for a timekeeping control primitive. The execution unit includes a first multiplier 567 coupled to receive and multiply a first timer offset 532-1 and frequency multiplier 534-2. In some embodiments, the first timer offset may optionally be provided from a register 571 (e.g., a model specific register (MSR) or other control and/or configuration register). In some embodiments, the frequency multiplier may optionally be provided from a virtualization control structure 572 (e.g., a VMCS). The execution unit includes an adder 568 coupled to receive and add an output of the first multiplier and a second timer offset 532-2. In some embodiments, the second timer offset may optionally be provided from the virtualization control structure. The first multiplier and the first adder represent an example of a timer offset determination unit 550. The execution unit includes a deterministic obfuscation circuitry 552 coupled to receive an output of the adder. The deterministic obfuscation circuitry may deterministically obfuscate the output of the adder to generate a deterministically obfuscated version of a timer offset 540. The circuitry may implement any of the algorithms described elsewhere herein (e.g., AES, SHA-2, etc.). The deterministically obfuscated version of a timer offset may be stored to a destination memory location or other destination storage location. The execution unit includes a second multiplier 569 coupled to receive and multiply an ART 573 and a timer/ART ratio 534-1. In some embodiments, the ART and the timer/ART ratio may be reported as CPU identification (CPUID) information, although that is not required. The execution unit includes a third multiplier 570 coupled to receive and multiply an output of the second multiplier and the frequency multiplier 534-2. The third multiplier may generate and output a frequency 544. The frequency may be stored to a destination register or other destination storage location. The second multiplier and the third multiplier represent an example of a frequency determination unit 554. A timer value 526 is also read from a timer (e.g., a TSC). The timer value may be stored in a destination register or other destination storage location.

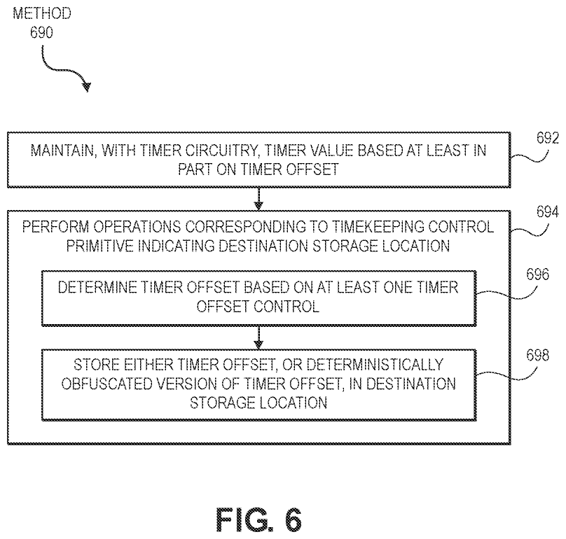

FIG. 6 is a block flow diagram of an embodiment of a method 690 of processing an embodiment of a timekeeping control primitive. In various embodiments, the method may be performed by a processor, integrated circuit, or system-on-a-chip (SoC). In some embodiments, the method 690 may be performed by the apparatus 222 of FIG. 2, the processor 312 of FIG. 3, or the apparatus 464 of FIG. 4. Alternatively, the method may be performed by similar or different processors. Moreover, the apparatus 222, processor 312, and apparatus 464 may perform methods the same as, similar to, or different than the method 690.

The method includes maintaining, with timer circuitry, a timer value based at least in part on a timer offset and a frequency of the timer circuitry, at block 692. In some embodiments, maintaining the timer value may include counting clock cycles and/or incrementing on clock cycles and/or decrementing on clock cycles. Any of the previously described types of timer circuitry are suitable. In some embodiments, the timer value may be maintained consistent with and/or based on one or more timer offset controls and one or more timer frequency controls. Any of the previously described types of timer controls are suitable.

The method also includes performing operations corresponding to a timekeeping control primitive, at block 694. Any of the previously described types of control primitives are suitable (e.g., instructions of an instruction set of a processor, ABI, API, or other commands stored in a MMIO register, requests or messages transmitted on an interface, etc.). The timekeeping control primitive may explicitly specify or otherwise indicate at least a first destination storage location. The first destination storage location may optionally be in registers (e.g., general-purpose registers or other architectural registers of a processor) and/or memory (e.g., one or more locations in main memory or system memory).

The operations include determining the timer offset based on at least one timer offset control, at block 696. In some embodiments, this may include determining the timer offset based on a first timer offset control (e.g., from IA32_TSC_ADJUST_MSR) and a second timer offset control (e.g., a TSC offset VM execution control from a VMCS).

The operations also include storing either the timer offset, or a deterministically obfuscated version of the timer offset, in the destination storage location, at block 698. In some embodiments, where the deterministically obfuscated version of the timer offset is stored, the operations may also include generating the deterministically obfuscated version of the timer offset by performing operations of a deterministically obfuscating function or algorithm on the timer offset. Any of the previously described types of deterministically obfuscating functions or algorithms are suitable. In some embodiments, the deterministically obfuscated version of the timer offset may optionally be obfuscated based on platform specific information (e.g., a platform unique AES key, a session identifier, etc.

In some embodiments, the method may also optionally include additional operations. For example, in some embodiments, the timekeeping control primitive may explicitly specify or otherwise indicate an optional second destination storage location, and the operations may also optionally include determining a frequency of the timer circuitry based on at least one timer frequency control, and storing the frequency of the timer circuitry or a deterministically obfuscated version of the frequency of the timer circuitry in the second destination storage location. Performing it in the same instruction may help to offer a potential advantage of atomicity in delivering both values. Alternatively, this may optionally be omitted or performed by a different instruction and if desired a transaction or other approaches may optionally be used to provide atomicity As another option, rather than storing a separate obfuscated frequency, the frequency and the offset may optionally be encrypted or otherwise obfuscated together into a single value.

As another example, in some embodiments, the timekeeping control primitive may explicitly specify or otherwise indicate an optional second destination storage location, and the operations may also optionally include reading or loading the timer value from the timer circuitry and storing the timer value in the third destination storage location. Performing it in the same instruction may help to offer a potential advantage of atomicity in delivering both values. Alternatively, this may optionally be omitted or performed by a different instruction (e.g., a RDTSC instruction) and if desired a transaction or other approaches may optionally be used to provide atomicity.

To further illustrate certain concepts, consider the following detailed example embodiments of a suitable timekeeping instruction, named STIME (Secure Timekeeping). This instruction when executed returns the TSC value (e.g., a timer value) along with its frequency and the obfuscated “TSC offset”.

Nominal ART frequency and TSC/ART ratio are reported via CPUID.15H, while their product (multiplied by “TSC multiplier”) is reported via STIME. In some embodiments, VMM may virtualize CPUID.15H to make “TSC multiplier” look like one, to help avoid revealing the existence of VMM to the guest VM, but this is not required in other embodiments as previously described.

STIME has an input in EBX/RBX that is the address of the buffer in system memory to receive the obfuscated TSC offset. STIME has the following outputs: (1) the obfuscated TSC offset is written to the buffer in system memory pointed to by EBX/RBX; (2) EDX:EAX is to receive the high/low 32 bits of current TSC value; (3) EBX:ECX is to receive the high/low 32 bits of TSC frequency.

The TSC frequency may be calculated by the execution unit (e.g., by micro-code) as:

EBX:ECX=ART_frequency*TSC_to_ART_ratio*(VM_TSC_multiplier)/2\hat{ }48
where VM_TSC_multipler is the “TSC multiplier” VM execution control. The ART_frequency and TSC_to_ART_ratio may be reported via CPUID.15H.

The obfuscated TSC offset is calculated by the execution unit (e.g., by micro-code) as:

T=AES_K(EID∥TSC_software_offset),
where K is the key for the AES encryption function (e.g., which may optionally be randomly generated at processor power on), PSID is an optional protected software ID (e.g., a 64-bit monotonic enclave ID incremented on every successful ECREATE). Incorporating the PSID in the obfuscated TSC offset may help to prevent a VM from being able to detect migration by observing different obfuscated TSC offsets in two different instances (one launched before and the other launched after the migration) of the same enclave. In other embodiments the PSID may optionally be omitted.

The 64-bit TSC_software_offset is calculated as

TSC_software_offset=IA32_TSC_ADJUST*(VM_TSC_multiplier)/2\hat{ }48+VM_TSC_offset
where VM_TSC_offset is the value of “TSC offset” VM execution control. The size of the obfuscated TSC offset may depend on the obfuscation algorithm. Often it is at least 64-bits in size (e.g., is 128 bits).

It is to be appreciated that this is just one illustrative example embodiment of a suitable timekeeping instruction. Other embodiments may optionally return the obfuscated offset without returning the frequency and/or the TSC value. Other embodiments may optionally replace the specific general-purpose registers with other registers or other storage locations. Other embodiments may optionally use different obfuscation algorithms. Other embodiments may use fewer, more, and/or different timer controls.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

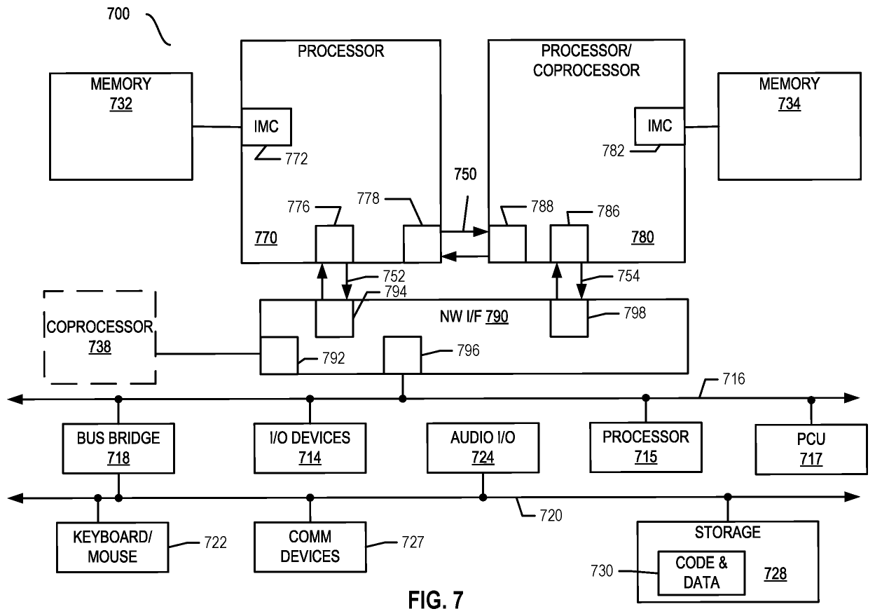

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage 'ISAB03 in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

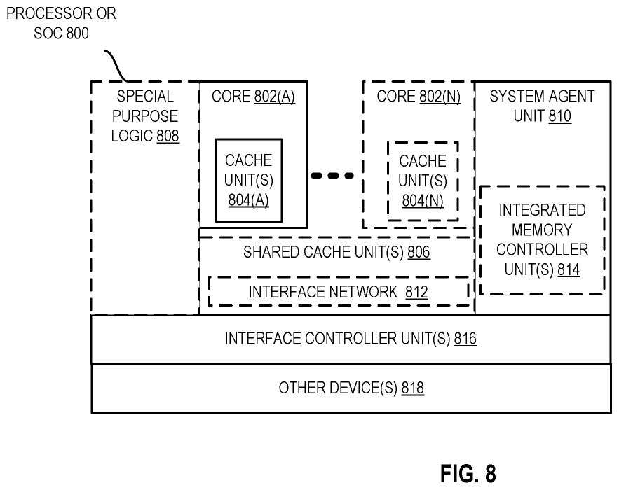

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

### Example Core Architectures—In-Order and Out-of-Order Core Block Diagram.

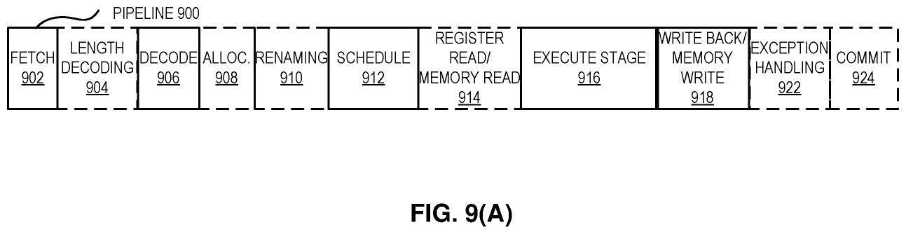

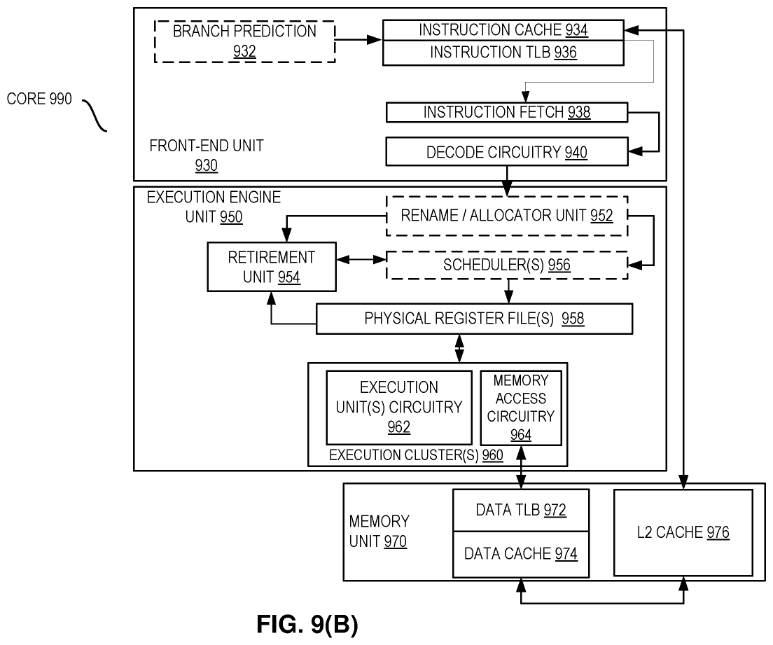

FIG. 9(A) is a block diagram illustrating both an example in-order pipeline and an example register renaming, out-of-order issue/execution pipeline according to examples. FIG. 9(B) is a block diagram illustrating both an example in-order architecture core and an example register renaming, out-of-order issue/execution architecture core to be included in a processor according to examples. The solid lined boxes in FIGS. 9(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9(A), a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 9(B) may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9(B) shows a processor core 990 including front-end unit circuitry 930 coupled to execution engine unit circuitry 950, and both are coupled to memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front-end unit circuitry 930 may include branch prediction circuitry 932 coupled to instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front-end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, address generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to data cache circuitry 974 coupled to level 2 (L2) cache circuitry 976. In one example, the memory access circuitry 964 may include load unit circuitry, store address unit circuitry, and store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Example Execution Unit(s) Circuitry.

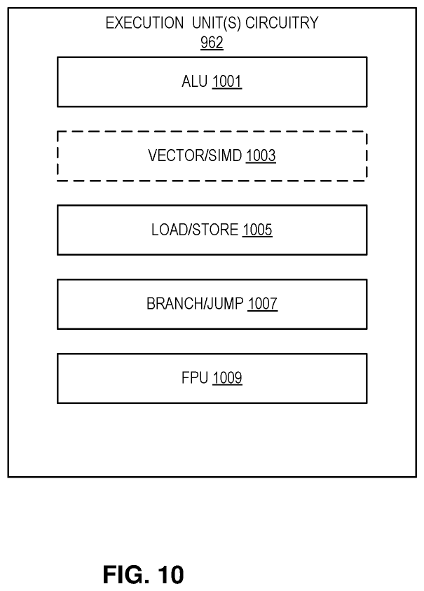

FIG. 10 illustrates examples of execution unit(s) circuitry, such as execution unit(s) circuitry 962 of FIG. 9(B). As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

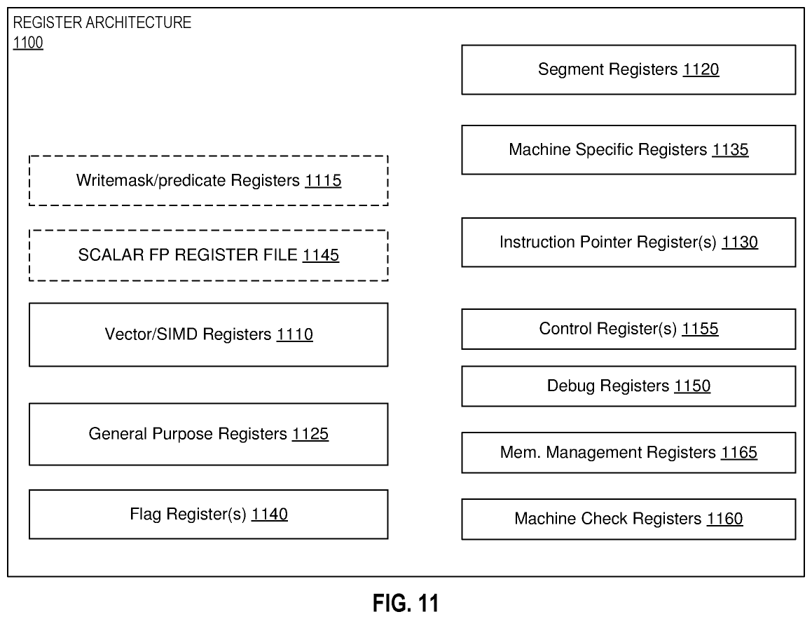

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register file 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Machine specific registers (MSRs) 1135 control and report on processor performance. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CR0-CR4) determine the operating mode of a processor (e.g., processor 770, 780, 738, 715, and/or 800) and the characteristics of a currently executing task. Debug registers 1150 control and allow for the monitoring of a processor or core's debugging operations.

Memory (mem) management registers 1165 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1100 may, for example, be used in register file/memory 'ISAB08, or physical register file(s) circuitry 9 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 12 illustrates examples of an instruction format. As illustrated, an instruction may include multiple components including, but not limited to, one or more fields for: one or more prefixes 1201, an opcode 1203, addressing information 1205 (e.g., register identifiers, memory addressing information, etc.), a displacement value 1207, and/or an immediate value 1209. Note that some instructions utilize some or all the fields of the format whereas others may only use the field for the opcode 1203. In some examples, the order illustrated is the order in which these fields are to be encoded, however, it should be appreciated that in other examples these fields may be encoded in a different order, combined, etc.

The prefix(es) field(s) 1201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1203 is used to at least partially define the operation to be performed upon a decoding of the instruction. In some examples, a primary opcode encoded in the opcode field 1203 is one, two, or three bytes in length. In other examples, a primary opcode can be a different length. An additional 3-bit opcode field is sometimes encoded in another field.

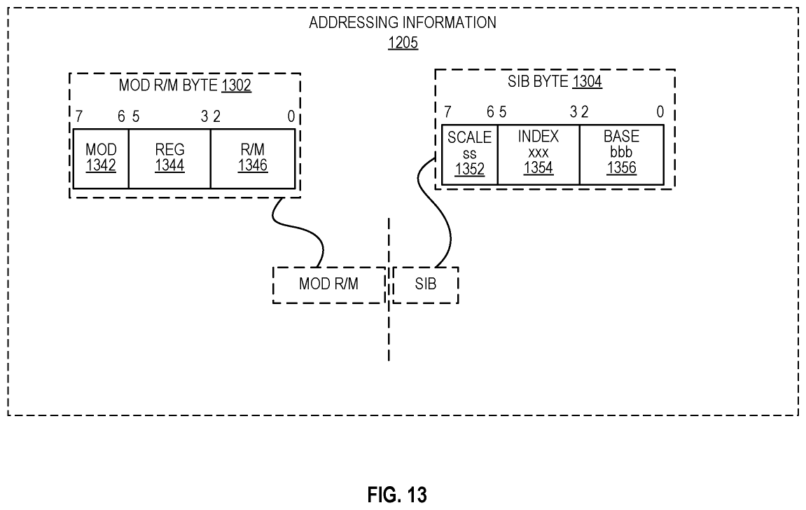

The addressing information field 1205 is used to address one or more operands of the instruction, such as a location in memory or one or more registers. FIG. 13 illustrates examples of the addressing information field 1205. In this illustration, an optional MOD R/M byte 1302 and an optional Scale, Index, Base (SIB) byte 1304 are shown. The MOD R/M byte 1302 and the SIB byte 1304 are used to encode up to two operands of an instruction, each of which is a direct register or effective memory address. Note that both of these fields are optional in that not all instructions include one or more of these fields. The MOD R/M byte 1302 includes a MOD field 1342, a register (reg) field 1344, and R/M field 1346.

The content of the MOD field 1342 distinguishes between memory access and non-memory access modes. In some examples, when the MOD field 1342 has a binary value of 11 (11b), a register-direct addressing mode is utilized, and otherwise a register-indirect addressing mode is used.

The register field 1344 may encode either the destination register operand or a source register operand or may encode an opcode extension and not be used to encode any instruction operand. The content of register field 1344, directly or through address generation, specifies the locations of a source or destination operand (either in a register or in memory). In some examples, the register field 1344 is supplemented with an additional bit from a prefix (e.g., prefix 1201) to allow for greater addressing.

The R/M field 1346 may be used to encode an instruction operand that references a memory address or may be used to encode either the destination register operand or a source register operand. Note the R/M field 1346 may be combined with the MOD field 1342 to dictate an addressing mode in some examples.

The SIB byte 1304 includes a scale field 1352, an index field 1354, and a base field 1356 to be used in the generation of an address. The scale field 1352 indicates a scaling factor. The index field 1354 specifies an index register to use. In some examples, the index field 1354 is supplemented with an additional bit from a prefix (e.g., prefix 1201) to allow for greater addressing. The base field 1356 specifies a base register to use. In some examples, the base field 1356 is supplemented with an additional bit from a prefix (e.g., prefix 1201) to allow for greater addressing. In practice, the content of the scale field 1352 allows for the scaling of the content of the index field 1354 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1207 provides this value. Additionally, in some examples, a displacement factor usage is encoded in the MOD field of the addressing information field 1205 that indicates a compressed displacement scheme for which a displacement value is calculated and stored in the displacement field 1207.

In some examples, the immediate value field 1209 specifies an immediate value for the instruction. An immediate value may be encoded as a 1-byte value, a 2-byte value, a 4-byte value, etc.

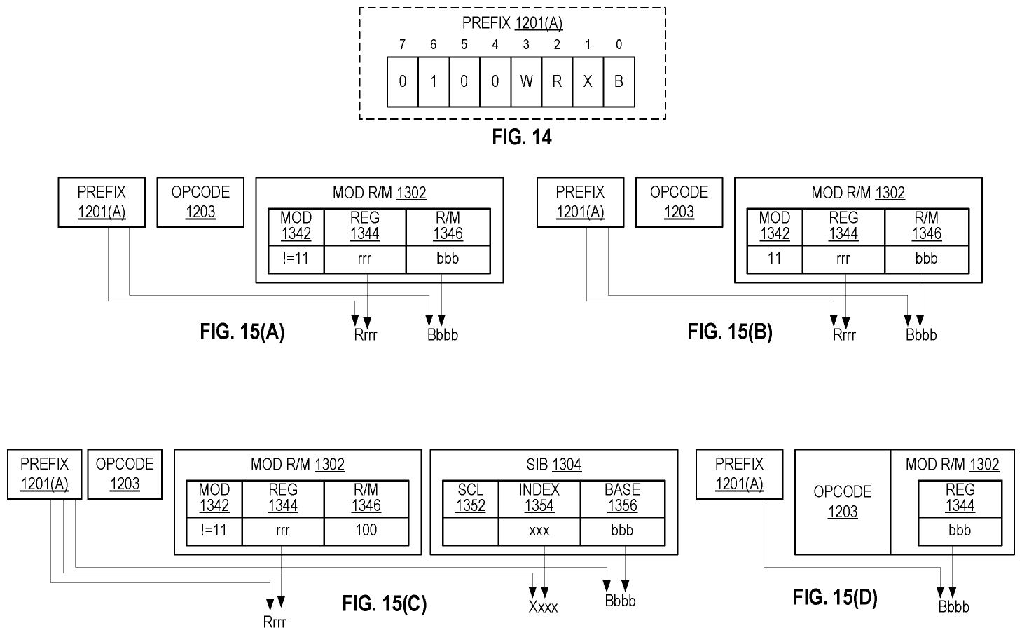

FIG. 14 illustrates examples of a first prefix 1201(A). In some examples, the first prefix 1201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1201(A) may specify up to three registers using 3-bit fields depending on the format: 1) using the reg field 1344 and the R/M field 1346 of the MOD R/M byte 1302; 2) using the MOD R/M byte 1302 with the SIB byte 1304 including using the reg field 1344 and the base field 1356 and index field 1354; or 3) using the register field of an opcode.

In the first prefix 1201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1344 and MOD R/M R/M field 1346 alone can each only address 8 registers.

In the first prefix 1201(A), bit position 2 (R) may be an extension of the MOD R/M reg field 1344 and may be used to modify the MOD R/M reg field 1344 when that field encodes a general-purpose register, a 64-bit packed data register (e.g., a SSE register), or a control or debug register. R is ignored when MOD R/M byte 1302 specifies other registers or defines an extended opcode.

Bit position 1 (X) may modify the SIB byte index field 1354.

Bit position 0 (B) may modify the base in the MOD R/M R/M field 1346 or the SIB byte base field 1356; or it may modify the opcode register field used for accessing general purpose registers (e.g., general purpose registers 1125).

FIGS. 15(A)-(D) illustrate examples of how the R, X, and B fields of the first prefix 1201(A) are used. FIG. 15(A) illustrates R and B from the first prefix 1201(A) being used to extend the reg field 1344 and R/M field 1346 of the MOD R/M byte 1302 when the SIB byte 13 04 is not used for memory addressing. FIG. 15(B) illustrates R and B from the first prefix 1201(A) being used to extend the reg field 1344 and R/M field 1346 of the MOD R/M byte 1302 when the SIB byte 13 04 is not used (register-register addressing). FIG. 15(C) illustrates R, X, and B from the first prefix 1201(A) being used to extend the reg field 1344 of the MOD R/M byte 1302 and the index field 1354 and base field 1356 when the SIB byte 13 04 being used for memory addressing. FIG. 15(D) illustrates B from the first prefix 1201(A) being used to extend the reg field 1344 of the MOD R/M byte 1302 when a register is encoded in the opcode 1203.

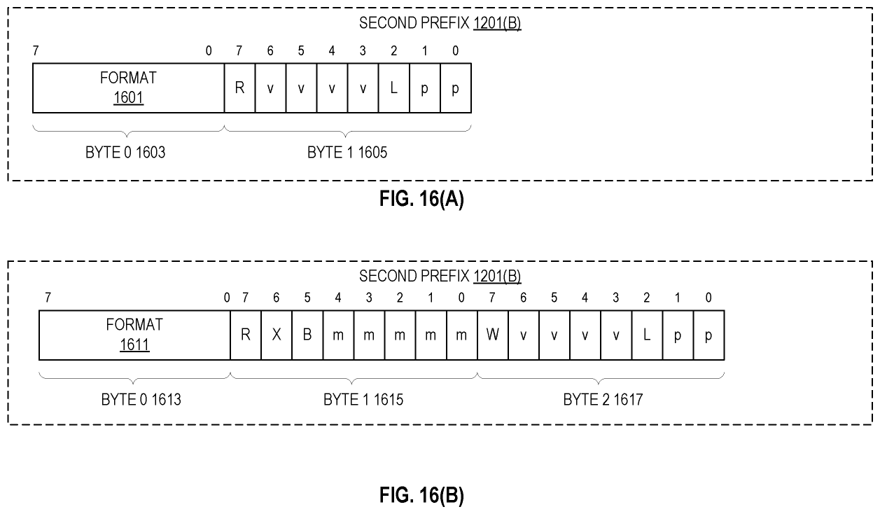

FIGS. 16(A)-(B) illustrate examples of a second prefix 1201(B). In some examples, the second prefix 1201(B) is an example of a VEX prefix. The second prefix 1201(B) encoding allows instructions to have more than two operands, and allows SIMD vector registers (e.g., vector/SIMD registers 1110) to be longer than 64-bits (e.g., 128-bit and 256-bit). The use of the second prefix 1201(B) provides for three-operand (or more) syntax. For example, previous two-operand instructions performed operations such as A=A+B, which overwrites a source operand. The use of the second prefix 1201(B) enables operands to perform nondestructive operations such as A=B+C.

In some examples, the second prefix 1201(B) comes in two forms—a two-byte form and a three-byte form. The two-byte second prefix 1201(B) is used mainly for 128-bit, scalar, and some 256-bit instructions; while the three-byte second prefix 1201(B) provides a compact replacement of the first prefix 1201(A) and 3-byte opcode instructions.

FIG. 16(A) illustrates examples of a two-byte form of the second prefix 1201(B). In one example, a format field 1601 (byte 0 1603) contains the value CSH. In one example, byte 1 1605 includes an “R” value in bit[7]. This value is the complement of the “R” value of the first prefix 1201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1346 to encode the instruction operand that references a memory address or encode either the destination register operand or a source register operand.

Instructions that use this prefix may use the MOD R/M reg field 1344 to encode either the destination register operand or a source register operand, or to be treated as an opcode extension and not used to encode any instruction operand.

For instruction syntax that support four operands, vvvv, the MOD R/M R/M field 1346 and the MOD R/M reg field 1344 encode three of the four operands. Bits[7:4] of the immediate value field 1209 are then used to encode the third source register operand.

FIG. 16(B) illustrates examples of a three-byte form of the second prefix 1201(B). In one example, a format field 1611 (byte 0 1613) contains the value C4H. Byte 1 1615 includes in bits[7:5]“R,” “X,” and “B” which are the complements of the same values of the first prefix 1201(A). Bits[4:0] of byte 1 1615 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1617 is used similar to W of the first prefix 1201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 111 lb.

Instructions that use this prefix may use the MOD R/M R/M field 1346 to encode the instruction operand that references a memory address or encode either the destination register operand or a source register operand.

Instructions that use this prefix may use the MOD R/M reg field 1344 to encode either the destination register operand or a source register operand, or to be treated as an opcode extension and not used to encode any instruction operand.

For instruction syntax that support four operands, vvvv, the MOD R/M R/M field 1346, and the MOD R/M reg field 1344 encode three of the four operands. Bits[7:4] of the immediate value field 1209 are then used to encode the third source register operand.

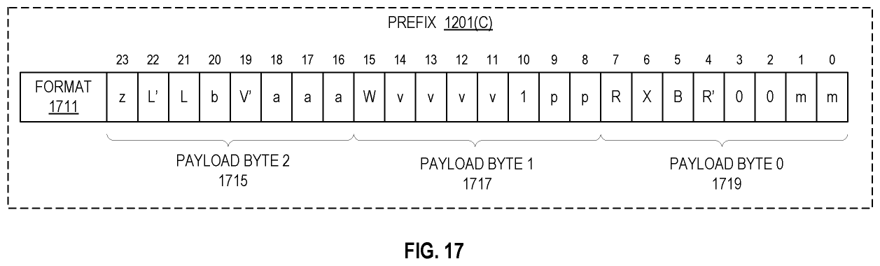

FIG. 17 illustrates examples of a third prefix 1201(C). In some examples, the third prefix 1201(C) is an example of an EVEX prefix. The third prefix 1201(C) is a four-byte prefix.

The third prefix 1201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 11) or predication utilize this prefix. Opmask register allow for conditional processing or selection control. Opmask instructions, whose source/destination operands are opmask registers and treat the content of an opmask register as a single value, are encoded using the second prefix 1201(B).

The third prefix 1201(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1201(C) is a format field 1711 that has a value, in one example, of 62H. Subsequent bytes are referred to as payload bytes 1715-1719 and collectively form a 24-bit value of P[23:0] providing specific capability in the form of one or more fields (detailed herein).

In some examples, P[1:0] of payload byte 1719 are identical to the low two mm bits. P[3:2] are reserved in some examples. Bit P[4](R′) allows access to the high 16 vector register set when combined with P[7] and the MOD R/M reg field 1344. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1344 and MOD R/M R/M field 1346. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 1201(A) and second prefix 1211(B) and may serve as an opcode extension bit or operand size promotion.

P[18:16] specify the index of a register in the opmask (writemask) registers (e.g., writemask/predicate registers 1115). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1201(C) are detailed in the following tables.

TABLE 1
32-Register Support in 64-bit Mode

| | | | | REG. | |
|---|---|---|---|---|---|
| | 4 | 3 | [2:0] | TYPE | COMMON USAGES |
| REG | R′ | R | MOD R/M | GPR, Vector | Destination or |
| | | | reg | | Source |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

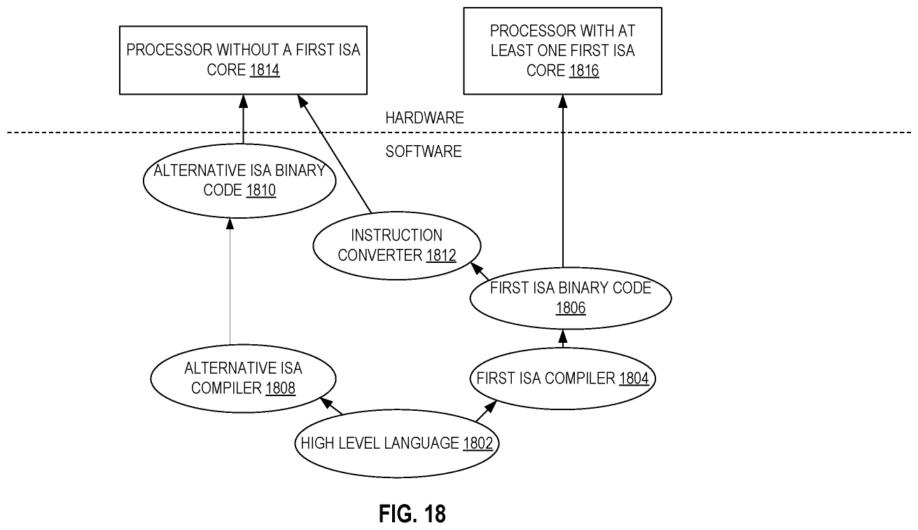

FIG. 18 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 18 shows a program in a high-level language 1802 may be compiled using a first ISA compiler 1804 to generate first ISA binary code 1806 that may be natively executed by a processor with at least one first ISA core 1816. The processor with at least one first ISA core 1816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1804 represents a compiler that is operable to generate first ISA binary code 1806 (e.g., object code) that can, with or without additional linkage processing, be executed on the processor with at least one first ISA core 1816. Similarly, FIG. 18 shows the program in the high-level language 1802 may be compiled using an alternative ISA compiler 1808 to generate alternative ISA binary code 1810 that may be natively executed by a processor without a first ISA core 1814. The instruction converter 1812 is used to convert the first ISA binary code 1806 into code that may be natively executed by the processor without a first ISA core 1814. This converted code is not necessarily to be the same as the alternative ISA binary code 1810; however, the converted code will accomplish the general operation and be made up of instructions from the alternative ISA. Thus, the instruction converter 1812 represents software, firmware, hardware, or a combination thereof that, through emulation, simulation or any other process, allows a processor or other electronic device that does not have a first ISA processor or core to execute the first ISA binary code 1806.

Components, features, and details described for any of FIGS. 1 and 3-5 may also optionally apply to any of FIGS. 2 and 6. Components, features, and details described for any of the apparatus disclosed herein (e.g., apparatus 222, processor 312, apparatus 464) may optionally apply to any of the methods disclosed herein (e.g., method 690), which in embodiments may optionally be performed by and/or with such apparatus. Any of the processors described herein (e.g., processor 312) in embodiments may optionally be included in any of the systems disclosed herein (e.g., any of the systems of FIGS. 7-8). Any of the processors disclosed herein (e.g., processor 312) may optionally have any of the microarchitectures shown herein. In addition, any of the instructions disclosed herein may in some embodiments optionally have any of the features or details of the instruction formats shown herein (e.g., the formats described for FIGS. 12-17).

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, an a first component may be coupled with a second component through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth in order to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail in order to avoid obscuring the understanding of the description.

### EXAMPLE EMBODIMENTS

The following examples pertain to further embodiments. Specifics in the examples may be used anywhere in one or more embodiments.

Example 1 is an apparatus including timer circuitry to provide a timer value based at least in part on a timer offset and an execution unit to perform operations corresponding to a timekeeping control primitive. The timekeeping control primitive is to indicate a destination storage location. The operations including to determine the timer offset based on at least one timer offset control, and store either the timer offset, or a deterministically obfuscated version of the timer offset, in the destination storage location.

Example 2 includes the apparatus of Example 1, where the execution unit is to store the deterministically obfuscated version of the timer offset in the destination storage location.

Example 3 includes the apparatus of Example 2, where the operations further include to generate the deterministically obfuscated version of the timer offset, including to perform operations of an algorithm on the timer offset.

Example 4 includes the apparatus of Example 3, where the algorithm is selected from a group consisting of encryption algorithms, cryptographic hash algorithms, hash-based message authentication code algorithms, pseudorandom functions, and collision resistant algorithms.

Example 5 includes the apparatus of any one of Examples 2 to 4, where the deterministically obfuscated version of the timer offset is obfuscated based on a platform unique value that does not persist across boots.

Example 6 includes the apparatus of any one of Examples 1 to 5, where the timekeeping control primitive is to indicate a second destination storage location. Also, optionally where the operations further include to determine a frequency of the timer circuitry based on at least one timer frequency control. Also, optionally where the operations further include to store either the frequency, or a deterministically obfuscated version of the frequency, in the second destination storage location.

Example 7 includes the apparatus of any one of Examples 1 to 6, where the timekeeping control primitive is to indicate a second destination storage location. Also optionally where the operations further include to store the timer value in the second destination storage location.

Example 8 includes the apparatus of any one of Examples 1 to 4, where the execution unit is to store the deterministically obfuscated version of the timer offset in the destination storage location. Also optionally where the deterministically obfuscated version of the timer offset is obfuscated based on a platform unique value that does not persist across boots. Also optionally where the timekeeping control primitive is to indicate a second destination storage location and a third destination storage location. Also optionally where the operations further include to determine a frequency of the timer circuitry based on at least one timer frequency control, and store the frequency in the second destination storage location. Also optionally where the operations include to store the timer value in the third destination storage location.

Example 9 includes the apparatus of any one of Examples 1 to 8, where the timekeeping control primitive is an instruction of an instruction set of a processor. Also optionally where the apparatus further includes decode unit coupled with the execution unit, the decode unit to decode the instruction.

Example 10 includes the apparatus of any one of Examples 1 to 8, where the timekeeping control primitive is a command to be stored in a control register.

Example 11 is a method including maintaining, with timer circuitry, a timer value based at least in part on a timer offset, and performing operations corresponding to a timekeeping control primitive, the timekeeping control primitive indicating a destination storage location. The operations including determining the timer offset based on at least one timer offset control, and storing either the timer offset, or a deterministically obfuscated version of the timer offset, in the destination storage location.

Example 12 includes the method of Example 11, where the storing includes storing the deterministically obfuscated version of the timer offset in the destination storage location.

Example 13 includes the method of Example 12, where the operations further include generating the deterministically obfuscated version of the timer offset by applying an algorithm to the timer offset.

Example 14 includes the method of Example 13, where the deterministically obfuscated version of the timer offset includes more than 64 bits. Also optionally where the storing includes storing the deterministically obfuscated version of the timer offset in a memory location. Also optionally where the algorithm is either an encryption algorithm or a cryptographic hash algorithm or a hash-based message authentication code algorithm.

Example 15 includes the method of any one of Examples 11 to 14, where the timekeeping control primitive indicates a second destination storage location. Also optionally where the operations further include determining a frequency of the timer circuitry based on at least one timer frequency control. Also optionally where the operations include storing either the frequency, or a deterministically obfuscated version of the frequency, in the second destination storage location.

Example 16. The method any one of Examples 11 to 15, where the timekeeping control primitive indicates a second destination storage location. Also optionally where the operations further include storing the timer value in the second destination storage location.

Example 17. The method any one of Examples 11 to 14, where the timekeeping control primitive indicates a second destination storage location and a third destination storage location. Also optionally where the operations further include determining a frequency of the timer circuitry based on at least one timer frequency control. Also optionally where the operations include storing the frequency in the second destination storage location. Also optionally where the operations include storing the timer value in the third destination storage location.

Example 18 is an article of manufacture including a non-transitory machine-readable storage medium. The non-transitory machine-readable storage medium storing instructions that if executed by a machine are to cause the machine to perform operations including to cause a processor to perform operations corresponding to a timekeeping control primitive. The operations including to determine a timer offset based on at least one timer offset control, where a timer value of a timer is to be based at least in part on the timer offset, and store either the timer offset, or a deterministically obfuscated version of the timer offset, in a destination storage location.

Example 19 includes the article of manufacture of Example 18, where the deterministically obfuscated version of the timer offset is to be stored in the destination storage location.

Example 20 includes the article of manufacture of any one of Examples 18 to 19, where the non-transitory machine-readable storage medium further stores instructions that if executed by the machine are to cause the machine to determine a frequency based on at least one timer frequency control, where the timer value of the timer is to be based at least in part on the frequency, and store either the frequency, or a deterministically obfuscated version of the frequency, in a second destination storage location.

Example 21 is an apparatus including means for maintaining a timer value based at least in part on a timer offset, and means for performing operations corresponding to a timekeeping control primitive. The timekeeping control primitive indicating a destination storage location. The means for performing operations including means for determining the timer offset based on at least one timer offset control, and means for storing either the timer offset, or a deterministically obfuscated version of the timer offset, in the destination storage location.

Example 22 is an apparatus to perform the method of any one of Examples 11 to 17.

Example 23 is an apparatus comprising circuitry to perform each of the operations of the method of any one of Examples 11 to 17.

Example 24 is an article of manufacture including a machine-readable medium including instructions that if executed by a machine are to cause the machine to perform the method of any one of Examples 11 to 17.

What is claimed is:

1. An apparatus comprising:
timer circuitry to provide a timer value based at least in part on a timer offset; and
an execution unit to perform operations corresponding to a timekeeping control primitive, the timekeeping control primitive to indicate a destination storage location, the operations including to:
determine the timer offset based on at least one timer offset control; and
store either the timer offset, or a deterministically obfuscated version of the timer offset, in the destination storage location.

2. The apparatus of claim 1, wherein the execution unit is to store the deterministically obfuscated version of the timer offset in the destination storage location.

3. The apparatus of claim 2, wherein the operations further include to generate the deterministically obfuscated version of the timer offset, including to perform operations of an algorithm on the timer offset.

4. The apparatus of claim 3, wherein the algorithm is selected from a group consisting of encryption algorithms, cryptographic hash algorithms, hash-based message authentication code algorithms, pseudorandom functions, and collision resistant algorithms.

5. The apparatus of claim 2, wherein the deterministically obfuscated version of the timer offset is obfuscated based on a platform unique value that does not persist across boots.

6. The apparatus of claim 1, wherein the timekeeping control primitive is to indicate a second destination storage location, and wherein the operations further include to:
determine a frequency of the timer circuitry based on at least one timer frequency control; and
store either the frequency, or a deterministically obfuscated version of the frequency, in the second destination storage location.

7. The apparatus of claim 1, wherein the timekeeping control primitive is to indicate a second destination storage location, and wherein the operations further include to store the timer value in the second destination storage location.

8. The apparatus of claim 1, wherein the execution unit is to store the deterministically obfuscated version of the timer offset in the destination storage location, wherein the deterministically obfuscated version of the timer offset is obfuscated based on a platform unique value that does not persist across boots, wherein the timekeeping control primitive is to indicate a second destination storage location and a third destination storage location, and wherein the operations further include to:
determine a frequency of the timer circuitry based on at least one timer frequency control;
store the frequency in the second destination storage location; and
store the timer value in the third destination storage location.

9. The apparatus of claim 1, wherein the timekeeping control primitive is an instruction of an instruction set of a processor, wherein the apparatus further comprises decode unit coupled with the execution unit, the decode unit to decode the instruction.

10. The apparatus of claim 1, wherein the timekeeping control primitive is a command to be stored in a location selected from a group consisting of a control register and a memory-mapped input/output (MMIO) region.

11. A method comprising:
maintaining, with timer circuitry, a timer value based at least in part on a timer offset; and
performing operations corresponding to a timekeeping control primitive, the timekeeping control primitive indicating a destination storage location, the operations including:
determining the timer offset based on at least one timer offset control; and
storing either the timer offset, or a deterministically obfuscated version of the timer offset, in the destination storage location.

12. The method of claim 11, wherein the storing comprises storing the deterministically obfuscated version of the timer offset in the destination storage location.

13. The method of claim 12, wherein the operations further include generating the deterministically obfuscated version of the timer offset by applying an algorithm to the timer offset.

14. The method of claim 13, wherein the deterministically obfuscated version of the timer offset comprises more than 64 bits, wherein the storing comprises storing the deterministically obfuscated version of the timer offset in a memory location, and wherein the algorithm is selected from a group consisting of encryption algorithms, cryptographic hash algorithms, hash-based message authentication code algorithms, pseudorandom functions, and collision resistant algorithms.

15. The method of claim 11, wherein the timekeeping control primitive indicates a second destination storage location, and wherein the operations further include:
determining a frequency of the timer circuitry based on at least one timer frequency control; and
storing either the frequency, or a deterministically obfuscated version of the frequency, in the second destination storage location.

16. The method of claim 11, wherein the timekeeping control primitive indicates a second destination storage location, and wherein the operations further include storing the timer value in the second destination storage location.

17. The method of claim 11, wherein the deterministically obfuscated version of the timer offset is stored in the destination storage location, wherein the deterministically obfuscated version of the timer offset is obfuscated based on a platform unique value that does not persist across boots, wherein the timekeeping control primitive indicates a second destination storage location and a third destination storage location, and wherein the operations further include:
determining a frequency of the timer circuitry based on at least one timer frequency control;
storing the frequency in the second destination storage location; and
storing the timer value in the third destination storage location.

18. An article of manufacture comprising a non-transitory machine-readable storage medium, the non-transitory machine-readable storage medium storing instructions that if executed by a machine are to cause the machine to perform operations comprising to:
cause a processor to perform operations corresponding to a timekeeping control primitive, the operations including to:
determine a timer offset based on at least one timer offset control, wherein a timer value of a timer is to be based at least in part on the timer offset; and
store either the timer offset, or a deterministically obfuscated version of the timer offset, in a destination storage location.

19. The article of manufacture of claim 18, wherein the deterministically obfuscated version of the timer offset is to be stored in the destination storage location.

20. The article of manufacture of claim 18, wherein the non-transitory machine-readable storage medium further stores instructions that if executed by the machine are to cause the machine to:
determine a frequency based on at least one timer frequency control, wherein the timer value of the timer is to be based at least in part on the frequency; and
store either the frequency, or a deterministically obfuscated version of the frequency, in a second destination storage location.
